(19) United States
(12) Patent Application Publication
(10) Pub. No.: US 2026/0067943 A1
(43) Pub. Date: Mar. 5, 2026

(54) SHARED TWO STEP AND FOUR STEP RACH OCCASIONS UNDER TIME DOMAIN PRACH ADAPTATION

(71) Applicant: QUALCOMM Incorporated, San Diego, CA (US)

(72) Inventors: Ahmed Attia ABOTABL, San Diego, CA (US); Diana MAAMARI, San Diego, CA (US); Muhammad Sayed Khairy ABDELGHAFFAR, San Jose, CA (US)

(21) Appl. No.: 18/818,542

(22) Filed: Aug. 28, 2024

(51) Int. Cl. H04W 74/0836

(52) U.S. Cl. CPC H04W 74/0836

(57) ABSTRACT

Methods and apparatuses are provided for the dynamic adaptation and sharing of random access channel (RACH) occasions in wireless communication networks for network energy savings (NES). A user equipment (UE) receives a configuration indicating whether a RACH occasion is shared between two-step and four-step random access. The UE receives information activating an additional RACH occasion, with an indication of whether it is shared. The UE transmits a two-step RACH preamble or a four-step RACH preamble in the additional RACH occasion based at least in part on the configuration or the information. The methods also include defining dedicated parameters for NES-capable UEs, dynamically indicating sharing properties of additional ROs, and allowing baseline ROs to adapt their sharing properties. Thus, the disclosed methods and apparatuses optimize resource utilization, reduce latency, and improve energy efficiency in wireless networks, ensuring efficient initial access and resource allocation while maintaining backward compatibility with non-NES capable UEs.

### TECHNICAL FIELD

The present disclosure generally pertains to the field of wireless communication, and more particularly, to the optimization of Random Access Channel (RACH) procedures, including the dynamic adaptation and sharing of two-step and four-step RACH occasions in the time domain.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure may be implemented in an apparatus for wireless communication, which may be a user equipment (UE). The apparatus includes one or more memories, and one or more processors each communicatively coupled with at least one of the one or more memories. The one or more processors, individually or in any combination, are operable to cause the apparatus to receive a configuration indicating whether a random access channel (RACH) occasion is shared between two-step random access and four-step random access, to receive information activating an additional RACH occasion, the configuration or the information indicating whether the additional RACH occasion is shared between the two-step random access and the four-step random access, and to transmit a two-step RACH preamble or a four-step RACH preamble in the additional RACH occasion based at least in part on the configuration or the information.

Another innovative aspect of the subject matter described in this disclosure may be implemented in a method for wireless communication performable at a UE. The method includes receiving a configuration indicating whether a RACH occasion is shared between two-step random access and four-step random access, receiving information activating an additional RACH occasion, the configuration or the information indicating whether the additional RACH occasion is shared between the two-step random access and the four-step random access, and transmitting a two-step RACH preamble or a four-step RACH preamble in the additional RACH occasion based at least in part on the configuration or the information.

Another innovative aspect of the subject matter described in this disclosure may be implemented in an apparatus for wireless communication, which may be a UE. The apparatus includes means for receiving a configuration indicating whether a RACH occasion is shared between two-step random access and four-step random access, the means for receiving being further configured to receive information activating an additional RACH occasion, the configuration or the information indicating whether the additional RACH occasion is shared between the two-step random access and the four-step random access, and means for transmitting a two-step RACH preamble or a four-step RACH preamble in the additional RACH occasion based at least in part on the configuration or the information.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2A is a diagram illustrating an example of a first subframe within a 5G NR frame structure.

FIG. 2B is a diagram illustrating an example of DL channels within a 5G NR subframe.

FIG. 2C is a diagram illustrating an example of a second subframe within a 5G NR frame structure.

FIG. 2D is a diagram illustrating an example of UL channels within a 5G NR subframe.

FIG. 3 is a block diagram illustrating an example of a base station and a UE involved in wireless communication.

FIG. 4 is a block diagram illustrating an example of a mapping of random access channel (RACH) preambles to PUSCH resource units in two-step random access.

FIG. 5 is a block diagram illustrating an example of unshared, baseline RACH occasions (ROs) and shared, additional ROs in the context of a two-step random access procedure in 5G NR.

FIG. 6 is a block diagram illustrating an example of a configuration of shared baseline ROs in the two-step random access procedure.

FIG. 7 is a diagram illustrating an example of a call flow between a base station and a UE incorporating various aspects of the present disclosure.

FIG. 8 is a flowchart of an example method of wireless communication performable at a UE.

FIG. 9 is a diagram illustrating an example of a hardware implementation for an apparatus that is a UE.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

The present disclosure relates to wireless communication systems, particularly to the optimization of random access channel (RACH) procedures in 5G New Radio (NR) networks through the dynamic adaptation and sharing of RACH occasions. Two-step RACH offers significant advantages over four-step RACH by reducing latency and signaling overhead, making it particularly suitable for applications requiring rapid and reliable access, such as massive Internet of Things (IoT) deployments and ultra-reliable low-latency communications (URLLC). Additionally, dynamic physical RACH (PRACH) adaptation in the time domain for network energy savings (NES) provides further improvements over the baseline random access occasions (ROs) semi-statically configured in two-step RACH. For example, a sparse configuration of baseline ROs that are not dynamically activated may initially be configured in a RACH configuration, and additional ROs may be dynamically activated or deactivated on an as-needed basis to optimize resource utilization and reduce unnecessary transmissions.

In the context of two-step RACH, a shared baseline RO feature allows for efficient resource allocation by enabling RACH occasions to be shared between two-step and four-step random access procedures. However, for two-step RACH to function effectively, the user equipment (UE) should have a reasonably high synchronization signal block-reference signal received power (SSB-RSRP). UEs with lower SSB-RSRP, typically located at the cell edge, may not benefit as much from the two-step RACH process. Therefore, aspects of the present disclosure provide for sharing configurations of dynamically activated additional ROs so that, for example, dynamically activated additional ROs do not have to follow the baseline ROs in terms of their sharing feature. This flexibility allows the network to serve a wider range of UEs, including those with varying SSB-RSRP levels, by semi-statically configuring or dynamically adapting the sharing properties of RACH occasions.

Aspects of the present disclosure thus relate to the sharing configuration and indication of dynamically adapted additional ROs in the two-step RACH procedure to realize optimized PRACH adaptation as well as the efficient utilization of additional PRACH resources. For instance, a UE may receive a configuration from a base station or other network entity indicating whether a RACH occasion is shared between two-step and four-step random access. The UE may also receive information activating an additional RACH occasion, with an indication of whether it is shared between two-step and four-step random access. Based on this configuration or information, the UE may transmit either a two-step RACH preamble or a four-step RACH preamble in the additional RACH occasion. This dynamic sharing capability allows the network to efficiently allocate resources based on current needs, ensuring that both cell center UEs with high SSB-RSRP and cell edge UEs with lower SSB-RSRP can be effectively served.

Accordingly, various aspects of the subject matter described in this disclosure relate generally to wireless communication systems, and more particularly to the dynamic adaptation and sharing of RACH occasions in 5G NR networks. Some aspects specifically relate to the optimization of RACH procedures through the flexible configuration and dynamic management of shared and unshared RACH occasions to enhance resource utilization, reduce latency, and improve energy efficiency. In various examples, apparatuses and methods are provided in which a UE receives a configuration indicating whether a RACH occasion is shared between two-step random access and four-step random access, receives information activating an additional RACH occasion, the configuration or the information indicating whether the additional RACH occasion is shared between the two-step random access and the four-step random access, and transmits a two-step RACH preamble or a four-step RACH preamble in the additional RACH occasion based at least in part on the configuration or the information.

Particular aspects relate to the specific configurations and dynamic adaptations of RACH occasions. In a first aspect, configurations may be provided where additional ROs and baseline ROs may be the same, sharing two-step and four-step preambles, or they may be different. In a second aspect, a dedicated parameter may be provided for NES-capable UEs, for example, one named msgA-CB-PreamblesPerSSB-PerSharedRO-r19, which applies to the additional ROs. If a shared RO parameter such as msgA-CB-PreamblesPerSSB-PerSharedRO-r16 or another name is not configured for non-NES capable UEs, then the baseline ROs may not be shared, but by defining a dedicated parameter for additional ROs such as msgA-CB-PreamblesPerSSB-PerSharedRO-r19, the UE may determine that the additional ROs are shared. If the shared RO parameter such as msgA-CB-PreamblesPerSSB-PerSharedRO-r16 is configured for non-NES capable UEs, the baseline ROs are shared, and the UE may follow an indicated number of preambles in the dedicated parameter for additional ROs. The dedicated parameter for additional ROs may take a value of zero to enable non-shared ROs. In a third aspect, if the baseline ROs are not shared, the additional ROs may be shared and may have the same number of two-step preambles as the baseline ROs, or the total number of preambles may be the same as the baseline ROs, either maintaining the number of two-step and four-step RACH preambles or splitting them to be shared. In a fourth aspect, a dynamic indication of the additional ROs may specify whether the additional ROs will be shared or not. In a fifth aspect, even baseline ROs may dynamically adapt to change their sharing properties.

Thus, particular aspects of the subject matter described in this disclosure may be implemented to realize one or more potential advantages. For example, the disclosed methods and apparatuses may optimize resource utilization, reduce latency, and improve energy efficiency in 5G NR networks by dynamically adapting and sharing RACH occasions. In various aspects, efficient initial access and resource allocation may be achieved by receiving a configuration indicating whether a RACH occasion is shared between two-step random access and four-step random access, receiving information activating an additional RACH occasion, with indications of whether it is shared, and transmitting a two-step RACH preamble or a four-step RACH preamble in the additional RACH occasion based at least in part on the configuration or the information. In addition, specific configurations and dynamic adaptations of RACH occasions may be achieved by providing configurations where additional ROs and baseline ROs may be the same or different, defining a dedicated parameter for NES-capable UEs, dynamically indicating whether additional ROs will be shared, and allowing baseline ROs to dynamically adapt their sharing properties. Based on one or more of these aspects, the network can efficiently manage its resources, ensuring optimal performance and reliability while maintaining backward compatibility with non-NES capable UEs.

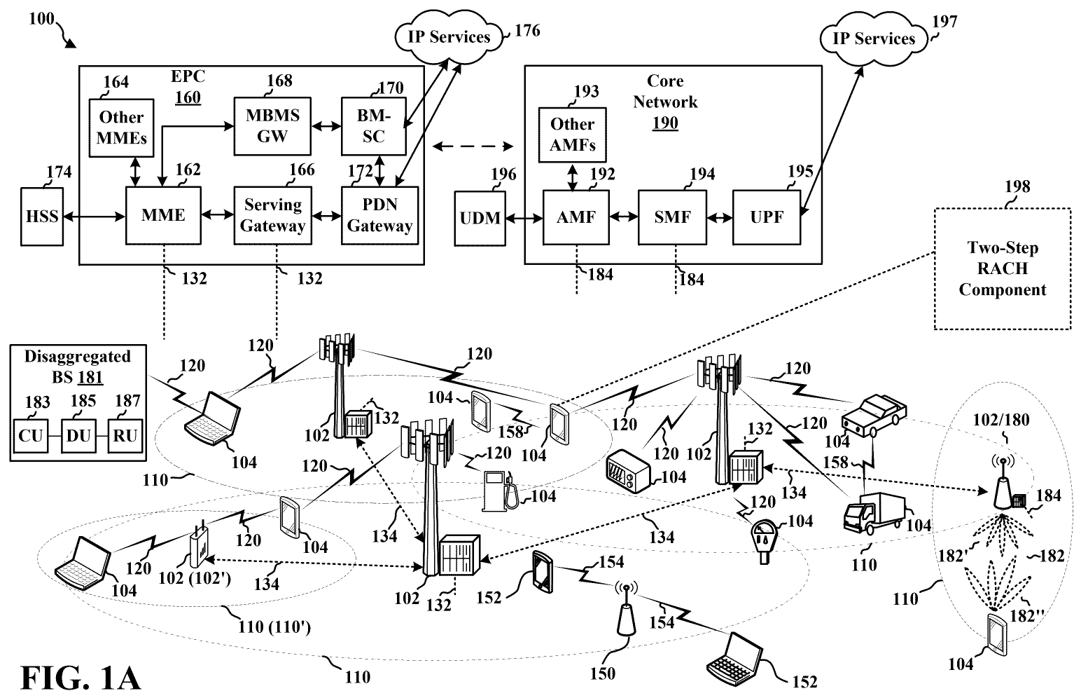

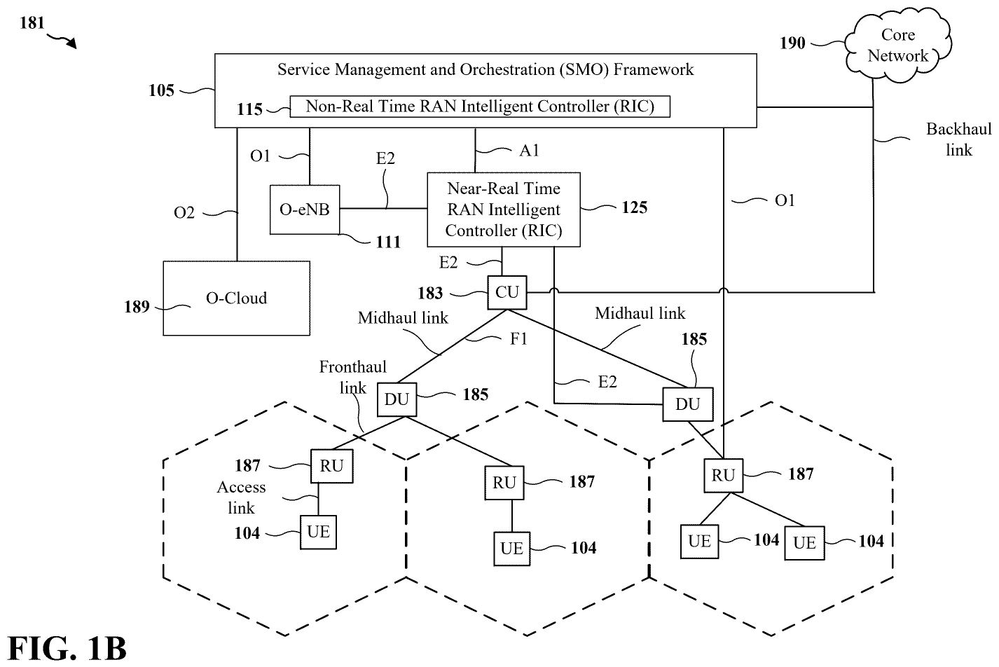

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

FIG. 1B shows a diagram illustrating an example disaggregated base station 181 architecture. The disaggregated base station 181 architecture may include one or more CUs 183 that may communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUs 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 may be logically split into one or more CU-UP units and one or more CU-CP units. The CU-UP unit may communicate bidirectionally with the CU-CP unit via an interface, such as the E1 interface when implemented in an O-RAN configuration. The CU 183 may be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) may implemented with an interface configured to communicate signals with other layers (and modules) hosted by the DU 185, or with the control functions hosted by the CU 183.

Lower-layer functionality may be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 may be implemented to handle over the air (OTA) communication with one or more UEs 104. In some implementations, real-time and non-real-time aspects of control and user plane communication with the RU(s) 187 may be controlled by the corresponding DU 185. In some scenarios, this configuration may enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements may include, but are not limited to, CUs 183, DUs 185, RUs 187 and Near-RT RICs 125. In some implementations, the SMO Framework 105 may communicate with a hardware aspect of a 4G RAN, such as an open eNB (O-eNB) 111, via an O1 interface. Additionally, in some implementations, the SMO Framework 105 may communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

Referring to FIGS. 1A and 1B, in certain aspects, the UE 104 may include a two-step RACH component 198 that is configured to receive a configuration indicating whether a RACH occasion is shared between two-step random access and four-step random access, receive information activating an additional RACH occasion, the configuration or the information indicating whether the additional RACH occasion is shared between the two-step random access and the four-step random access, and transmit a two-step RACH preamble or a four-step RACH preamble in the additional RACH occasion based at least in part on the configuration or the information.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

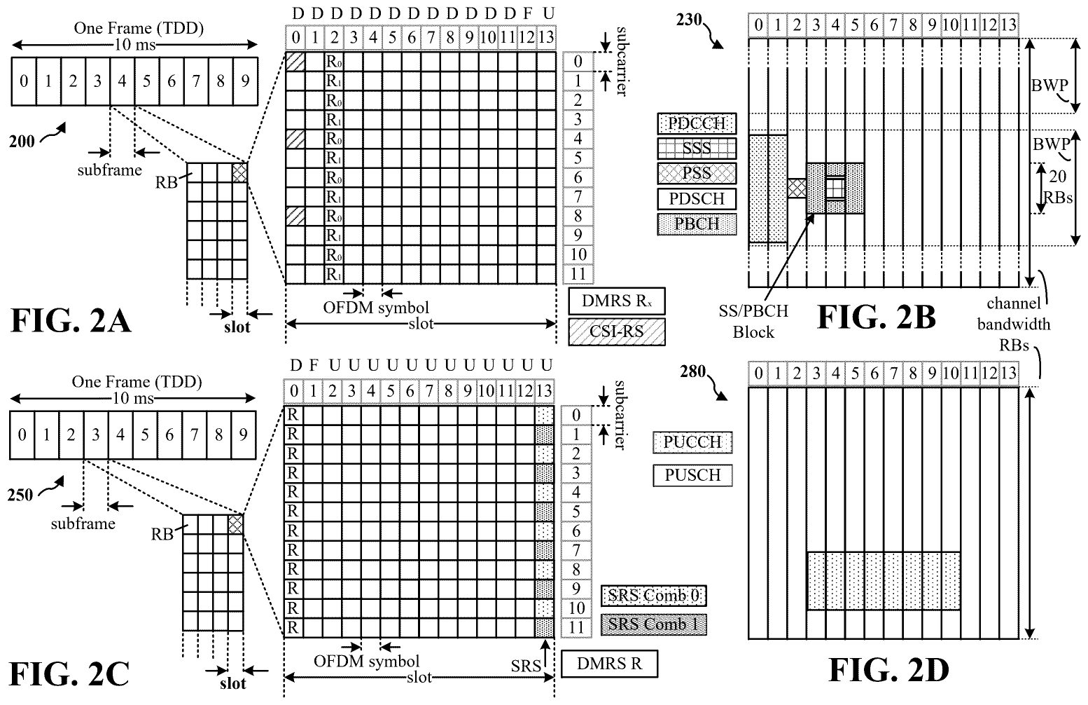

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2\hat{ }μ*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE may determine a physical cell identifier (PCI). Based on the PCI, the UE may determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

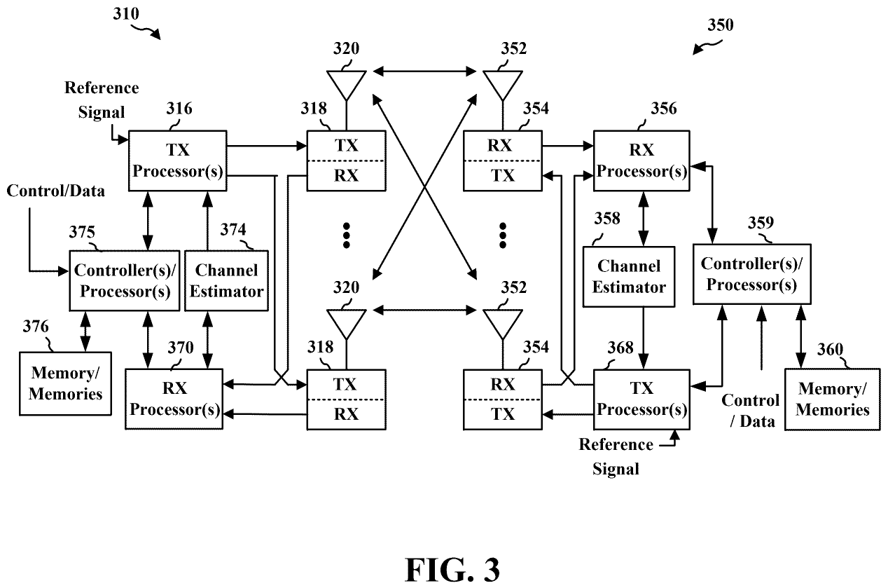

FIG. 3 is a block diagram of a base station 310 such as base station 102/180 in communication with a UE 350 such as UE 104 in an access network. IP packets from the EPC 160 may be provided to one or more controllers/processors 375 of base station 310. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer protocol data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 of base station 310 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 of UE 350 implement layer 1 functionality associated with various signal processing functions. The one or more RX processors 356 may perform spatial processing on the information to recover any spatial streams destined for the UE 350. If multiple spatial streams are destined for the UE 350, they may be combined by the one or more RX processors 356 into a single OFDM symbol stream. The one or more RX processors 356 then convert the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the one or more controllers/processors 359 of UE 350, which implement layer 3 and layer 2 functionality.

The one or more controllers/processors 359 may each be associated with one or more memories 360 that store program codes and data. The one or more memories 360, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). The one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with transmission by the base station 310, the one or more controllers/processors 359 of UE 350 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to one or more RX processors 370.

The one or more controllers/processors 375 may each be associated with one or more memories 376 that store program codes and data. The one or more memories 376, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). The one or more controllers/processors 375 provide demultiplexing between transport and logical channels, packet reassembly, deciphering, header decompression, control signal processing to recover IP packets from the UE 350. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 368, the one or more RX processors 356, and the one or more controllers/processors 359, may be configured to perform aspects in connection with two-step RACH component 198 of FIG. 1A.

The 2-step random access channel (RACH) procedure in 5G/NR is a streamlined approach designed to enhance the efficiency and speed of initial access between UEs and the network. This process is a significant evolution from the traditional 4-step RACH process used in previous generations of mobile networks, such as LTE. The 2-step RACH process reduces latency and signaling overhead, making it particularly suitable for applications requiring rapid and reliable access, such as massive IoT deployments and ultra-reliable low-latency communications (URLLC).

In the traditional 4-step RACH procedure, the UE initiates communication with the network through a series of four steps: preamble transmission, random access response, physical uplink shared channel (PUSCH) transmission, and contention resolution completion. This process, while effective, can introduce delays due to the multiple exchanges required between the UE and the network. The 2-step RACH procedure simplifies this process by combining some of these steps, thereby reducing the number of interactions and the overall time required for initial access. This is achieved by integrating the preamble transmission and the initial PUSCH message (msgA) into a single step, followed by a response from the network (msgB).

More particularly, the first step in the 2-step RACH process involves the transmission of the preamble by the UE. The UE selects a RACH Occasion (RO), which is a specific allocation of time and frequency resources for transmitting the preamble. The preamble is a short, unique sequence that helps the network identify the UE. Multiple UEs can share the same RO by using different preamble sequences, a technique known as code domain multiplexing. This allows simultaneous transmissions without interference, as each UE uses a unique code.

The UE also transmits the msgA payload in a PUSCH Occasion (PO) associated with the selected RO. The PO refers to the specific time and frequency resources allocated for the transmission of msgA PUSCH. To support asynchronous uplink transmission, guard time (GT) and guard band (GB) may be configured for each PO. Guard time is a buffer period to account for timing misalignments, while guard band is a frequency buffer to prevent adjacent channel interference. These configurations help mitigate inter-symbol interference (ISI) and inter-carrier interference (ICI).

The PUSCH resource unit (PRU) is a combination of the PO and the demodulation reference signal (DMRS) port or sequence used for msgA payload transmission. The DMRS is a reference signal that the receiver uses to estimate the channel and accurately demodulate the received signal. Each PRU specifies the exact resources, including time and frequency used for transmitting the msgA payload with DMRS. This precise allocation ensures that the network can correctly decode the transmitted data.

The contents and size of the msgA payload may vary depending on the use cases and link qualities. In the radio resource control (RRC) idle or inactive states, where the UE is not actively communicating with the network, the msgA payload may include a unique UE identifier, RRC requests, or small data packets. These elements help the network recognize the UE, process resource requests, or receive occasional updates. In the RRC CONNECTED state, where the UE is actively communicating, the msgA payload may include medium access control (MAC) control elements (CE), user plane data such as voice or video, or control plane data related to network operations.

Upon receiving the preamble and PUSCH data in msgA, the network processes the information and allocates resources for the UE. The network sends a response, known as msgB, which includes the necessary information for the UE to continue communication. The msgB typically contains timing advance commands, uplink resource grants, and other control information required for the UE to synchronize and communicate effectively with the network.

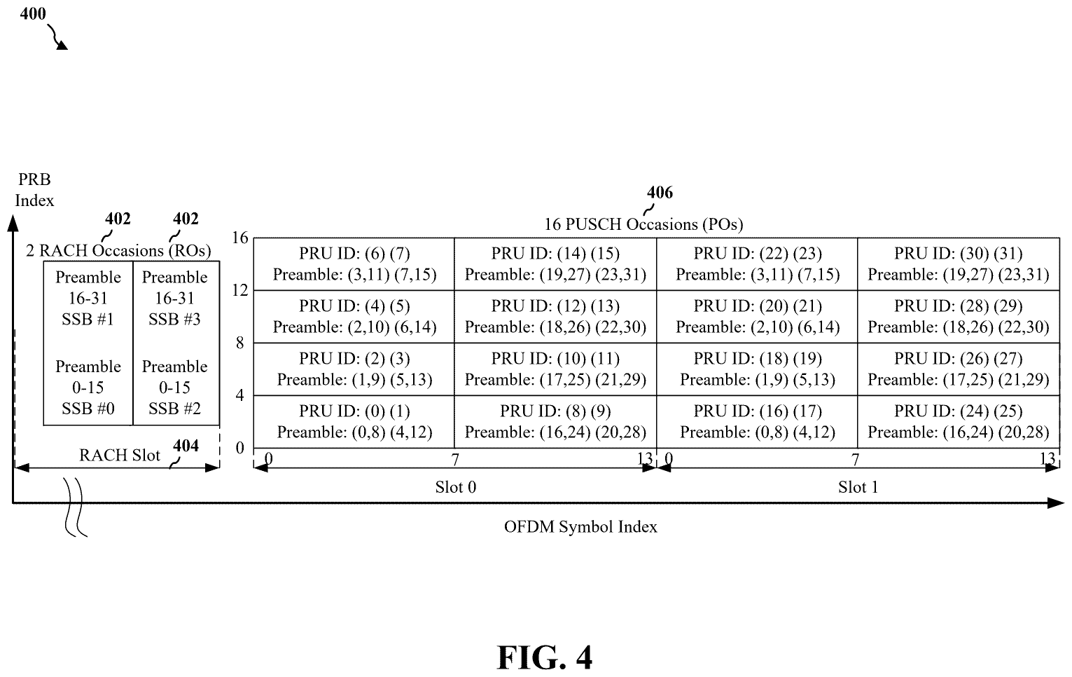

FIG. 4 illustrates an example 400 of a mapping of RACH preambles to PRUs in 2-step RACH. This mapping process allows the resources to be efficiently allocated so that multiple UEs may access the network simultaneously without interference for transmission of msgA to the network. The mapping also follows a structured order to maintain the integrity and reliability of the msgA communication.

As illustrated, each consecutive number of preamble indexes (N_{preamble}) from valid PRACH occasions 402 in a PRACH slot 404 is mapped in a specific sequence. First, the preambles are ordered in increasing order of preamble indexes within a single PRACH occasion 402. Second, they are ordered in increasing order of frequency resource indexes for frequency-multiplexed PRACH occasions. Third, they are ordered in increasing order of time resource indexes for time-multiplexed PRACH occasions within PRACH slot 404. This ordered sequence of preambles is then mapped to a valid PUSCH occasion and an associated DMRS resource.

The mapping of preambles to PUSCH occasions 406 also follows a structured order. First, the preambles are ordered in increasing order of frequency resource indexes (f_{id}) for frequency-multiplexed PUSCH occasions. Second, they are ordered in increasing order of DMRS resource indexes within a PUSCH occasion. The DMRS resource index (DMRS_{id}) is determined first in an ascending order of a DMRS port index and second in an ascending order of a DMRS sequence index. Third, the preambles are ordered in increasing order of time resource indexes (t_{id}) for time-multiplexed PUSCH occasions within a PUSCH slot. Finally, they are ordered in increasing order of indexes for a number Nₛ of PUSCH slots.

An example of this mapping process is shown by the specific channel structure for msgA illustrated in FIG. 4. In this example, multiple ROs and POs may be configured in association with different Synchronization Signal Blocks (SSBs). For instance, preambles 0-15 may be associated with SSB 0 and preambles 16-31 may associated with SSB 1 in one PRACH occasion 402 or RO within PRACH slot 404, while preambles 0-15 may be associated with SSB 2 and preambles 16-31 may be associated with SSB 3 in another PRACH occasion 402 or RO within PRACH slot 404. This pattern may continue for other SSBs in order of frequency followed by time. Each preamble is then mapped to specific PRU IDs. For example, the PUSCH occasion 406 corresponding to PRU ID 0 may be associated with preambles 0 and 8, the PUSCH occasion 406 corresponding to PRU ID 1 may be associated with preambles 4 and 12, and so forth as illustrated, in order of frequency followed by time.

The number of preambles (N_{preamble}) mapped to ROs and POs is calculated based on the ratio of the total number of valid PRACH occasions per association pattern period (T_{preamble}) to the total number of valid PUSCH occasions per PUSCH configuration per association pattern period (T_{PUSCH}). T_{preamble} is determined by multiplying the total number of valid PRACH occasions per association pattern period by the number of preambles per valid PRACH occasion, as provided by rach-ConfigCommonTwoStepRA. T_{PUSCH} is determined by multiplying the total number of valid PUSCH occasions per PUSCH configuration per association pattern period by the number of DMRS resource indexes per valid PUSCH occasion, as provided by msgA-DMRS-Config.

To accommodate various use cases and coverage requirements, the network supports multiple formats of PUSCH occasions 406. This flexibility ensures that the system can efficiently handle different types of traffic and link conditions. However, the bursty nature of msgA traffic, characterized by short bursts of data transmission rather than continuous flow, may in some cases make fixed resource allocation inefficient. Therefore, it would be helpful to apply dynamic resource allocation strategies to optimize resource usage and improve system efficiency.

To this end, network energy savings (NES) strategies including dynamic adaptations have been considered. These strategies involve specifying changes to common signaling channel transmissions, such as the adaptation of SSBs or PRACH in the time domain. For instance, the periodicity of SSBs may be adjusted to reduce unnecessary transmissions, or the timing of PRACH occasions may be adjusted to match the network's current load and conditions. Additionally, PRACH may also be adapted in the spatial domain, such as by providing non-uniform PRACH resources per SSB. Moreover, paging occasions may also be adapted. This may include confining paging occasions within specific time domains to optimize energy usage without providing any increase in paging latency. These strategies help to reduce the energy consumption of both the network and the UEs.

In regard to dynamic adaptation of the PRACH in the time domain, this NES strategy allows for PRACH resources and their associated PUSCH resources to be used efficiently, reducing unnecessary transmissions and saving energy. For example, the network may configure sparse PRACH occasions initially for random access operations, while dynamically activating or deactivating additional RACH occasions based on the network deployment and the needs of the UEs. This time-domain (TD) adaptation of PRACH may be performed by semi-statically configuring additional PRACH resources and dynamically activating or deactivating them based on network conditions and requirements. For instance, the network may define additional PRACH resources in a RACH configuration or other semi-static configuration, and then dynamically manage, activate, or deactivate these additional RACH resources using higher-layer signaling or Layer 1-based adaptation to optimize energy efficiency and resource utilization. By dynamically managing additional ROs in this manner, the network can adapt to varying traffic loads and conditions, ensuring efficient use of resources and reducing unnecessary energy consumption.

However, for any of these adaptations, including the adaptation of PRACH in the time domain, UEs without NES capabilities should not be negatively impacted. For example, a SSB to RO mapping for additional PRACH resources may be separate from an SSB-RO mapping of PRACH resources for non-NES capable UEs. This separation ensures that PRACH resources introduced for NES do not interfere with the resources used by non-NES capable UEs, maintaining backward compatibility, network stability, and ensuring that non-NES capable UEs are not impacted if NES capable UEs use PRACH resources.

Moreover, when introducing additional RACH occasions dynamically in NES, it would be desirable to separately define a shared RO status for these occasions so as not to impact UEs without NES capabilities. For example, it would be helpful for the network to configure whether or not dynamically activated additional ROs for NES will be shared between two-step or four-step random access separately from the baseline ROs. Such configuration may allow the UE to determine whether or not a dynamically activated RO and associated PO may be applied for 4-step or 2-step random access preamble transmissions, which may be an important consideration for massive IoT deployments, URLLC, or other applications requiring rapid and reliable access.

Currently, a 2-step RACH configuration may include a feature that indicates whether baseline ROs are to be shared between the 4-step and 2-step RACH processes. In 4-step random access, the network may instruct the UE to transmit a preamble and wait for a response before transmitting a PUSCH payload, while in 2-step random access, the UE may transmit a preamble and the PUSCH payload in designated occasions without first waiting for a response from the network. If an RO is shared, that RO may be used for either or both the 2-step and 4-step RACH processes. For example, if a shared RO is associated with 32 preambles such as illustrated in FIG. 4, sixteen of these preambles may be allocated for 2-step random access while the other sixteen preambles may be allocated for 4-step random access. This allows UEs to transmit preambles and payloads according to their specific RACH process requirements.

However, for 2-step random access to function effectively, the UE should have a reasonably high SSB-reference signal received power (SSB-RSRP). Otherwise, even if 2-step random access is configured, a UE may not use it if their SSB-RSRP is not sufficiently high. Typically, UEs closer to the cell center, which have higher SSB-RSRP, may be more likely to use 2-step random access, while UEs at the cell edge, with lower SSB-RSRP, may rely on 4-step random access to ensure successful communication.

Therefore, in the case of PRACH adaptation in the time domain, if 2-step random access is configured with a sparse configuration of ROs for network energy-saving purposes, and additional ROs are semi-statically configured to be dynamically activated when needed, then it would be desirable for these additional ROs to not have to follow the baseline ROs in terms of being shared between the 2-step and 4-step RACH processes. For example, even if the baseline ROs are configured to be unshared to serve cell center UEs with high SSB-RSRPs, the additional ROs may be configured to be shared to serve both cell center UEs and cell edge UEs with low SSB-RSRPs. This would be particularly useful when the network activates these additional ROs dynamically for short periods to handle increased traffic or specific network conditions. The additional ROs would not have to follow, but could still follow, the same configuration as the baseline ROs, allowing the network to optimize their use based on current needs. For instance, if the network wants to serve more UEs, it can configure the additional ROs to be shared, enabling both cell center and cell edge UEs to use them.

This flexibility would allow the network to serve a wider range of UEs when it activates additional ROs, ensuring that the network can adapt to varying conditions and requirements. The flexibility in configuring these additional ROs would allow the network to dynamically adapt to different scenarios, such as varying traffic loads or specific service requirements. This dynamic adaptation would be achieved through the semi-static configuration, where the network defines or configures the additional ROs, and then through dynamic activation or deactivation of these ROs based on real-time conditions. This approach ensures that the network can efficiently manage its resources, providing optimal service to UEs while minimizing energy consumption.

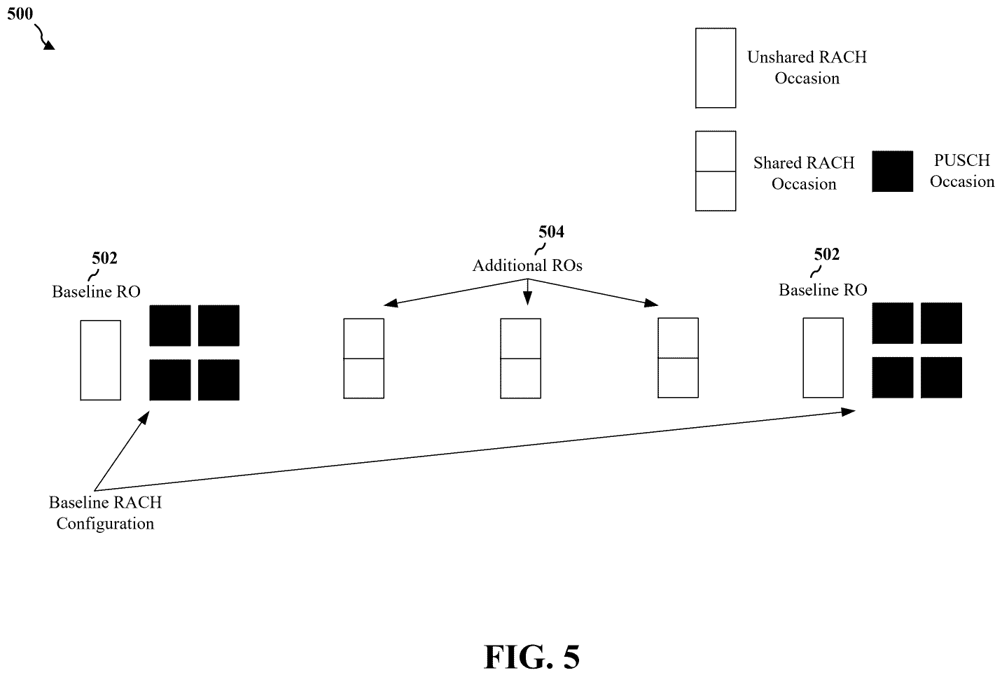

FIG. 5 illustrates an example 500 of unshared, baseline ROs 502 and shared, additional ROs 504 in the context of a two-step random access procedure in 5G NR. In a baseline configuration, ROs 502 may typically be unshared, and thus they are dedicated only to the 2-step RACH process. For instance, FIG. 5 illustrates unshared RACH occasions corresponding to PRACH occasions 402, where the resources are exclusively allocated for the 2-step RACH process. Alongside the unshared RACH occasions, there is a corresponding PUSCH occasion corresponding to PUSCH occasion 406, which is used for transmitting the payload in the 2-step RACH process.

The concept of shared RACH occasions may enhance the flexibility and efficiency of the network. In a shared RACH occasion, the resources may be used for both the 4-step and the 2-step RACH processes. Thus, a single RACH occasion may serve multiple purposes, allowing the network to dynamically allocate resources based on current needs and conditions. For instance, FIG. 5 illustrates multiple shared RACH occasions, where the resources are divided between the 4-step and the 2-step RACH processes. For example, if an RO has 32 preambles, 16 of these preambles may be allocated for the 2-step RACH and the other sixteen for the 4-step RACH. This sharing allows the network to serve a wider range of UEs, including those with both low and high SSB-RSRPs.

As an example, in scenarios where the baseline ROs 502 are not shared, the network may activate shared, additional ROs 504 to serve cell edge UEs. For instance, if the network detects that there are no cell edge UEs at a given moment, all baseline ROs may be configured as unshared for the 2-step RACH. However, if the network detects the presence of cell edge UEs, it may dynamically activate additional ROs 504 and configure them to be shared. This allows the network to serve both cell center UEs using the 2-step RACH and cell edge UEs using the 4-step RACH.

This dynamic activation and sharing of ROs ensure that the network can adapt to varying conditions and requirements, optimizing resource utilization and energy efficiency. For example, UEs closer to the cell center typically have a higher SSB-RSRP and can effectively use the 2-step RACH. In contrast, cell edge UEs, with lower SSB-RSRP, may rely on the 4-step RACH to ensure successful communication. By dynamically managing the ROs, the network can turn off certain capabilities when there are no cell edge UEs, saving energy. For example, the network may change the additional ROs 504 to become unshared like baseline ROs 502, or the network may deactivate the additional ROs 504. When cell edge UEs are detected, the network can activate additional ROs 504 to serve them, ensuring comprehensive coverage and service quality. This dynamic adaptation of ROs thus allows the network to serve UEs without being limited by the SSB-RSRP. Thus even cell edge UEs may benefit from shared ROs, enhancing the overall flexibility and efficiency of the network.

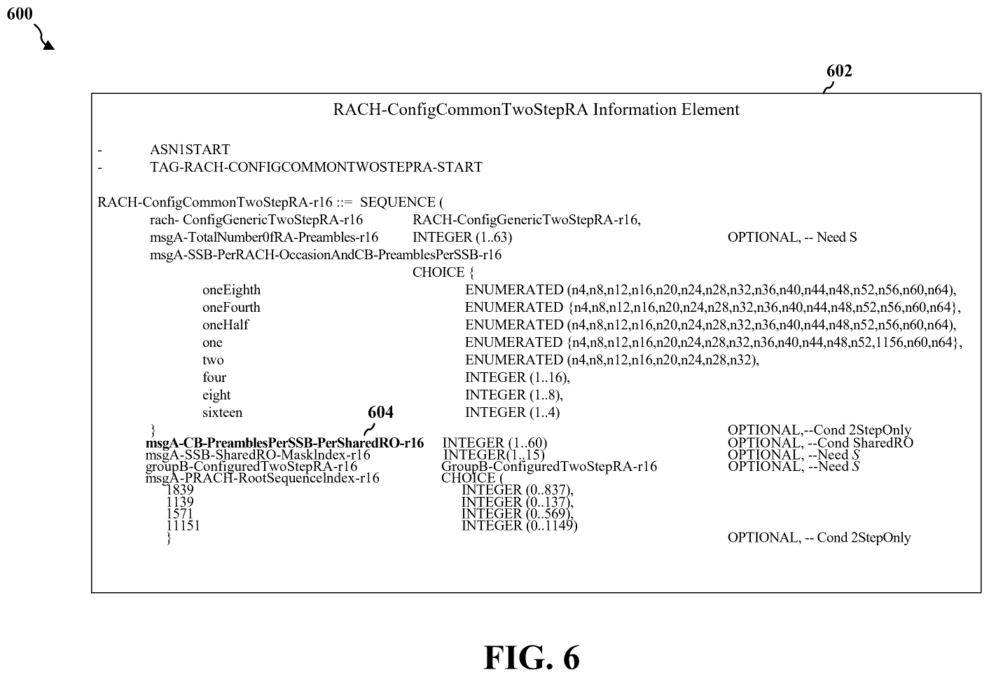

FIG. 6 illustrates an example 600 of a configuration 602 of shared baseline ROs in the two-step random access procedure. In this example, an RRC configuration defining shared baseline ROs may be given by the RACH-ConfigCommonTwoStepRA information element, although a different element or configuration may define shared ROs in other examples. This element specifies the parameters and conditions under which shared ROs may be configured and utilized.

The RACH-ConfigCommonTwoStepRA information element or other configuration 602 in this example may include several parameters. One of the primary parameters is msgA-TotalNumberOfRA-Preambles-r16, which defines the total number of random access preambles available for the 2-step random access procedure. Another important parameter is the msgA-SSB-PerRACH-OccasionAndCB-PreamblesPerSSB-r16, which specifies the number of preambles per SSB for each RACH occasion. This parameter can take different values indicating the fraction of preambles allocated per SSB. The choice of these values depends on the network's configuration and the specific requirements of the random access process. The RACH-ConfigCommonTwoStepRA-r16 element may also include a choice of enumerated values for various parameters, such as the number of preambles.

The RACH-ConfigCommonTwoStepRA information element or other configuration 602 in this example may also include a shared RO parameter 604, such as msgA-CB-PreamblesPerSSB-PerSharedRO-r16. This shared RO parameter 604 defines whether PRACH occasions 402 or baseline ROs 502 are shared. More particularly, this shared RO parameter 604 defines the number of contention-based preambles used for the 2-step random access type from the non-Contention-Based Random Access (CBRA) 4-step type preambles associated with each SSB for ROs shared with the 4-step type random access. The number of preambles for the 2-step random access type may not exceed the number of preambles per SSB minus the number of contention-based preambles per SSB for the 4-step type random access. This ensures that the shared ROs are efficiently utilized without causing conflicts or interference between the 2-step and 4-step random access processes. Relatedly, the msgA-SSB-SharedRO-MaskIndex-r16 parameter specifies the mask index for shared ROs in relation to associated SSBs. This parameter helps in identifying and managing the shared baseline ROs mapped to different SSBs. If this parameter is absent, it indicates that all baseline ROs are shared. If present, it specifies which baseline ROs mapped to different SSBs are shared, allowing for more precise control over resource allocation. The RACH-ConfigCommonTwoStepRA information element or configuration 602 also includes conditions for optional parameters including the msgA-CB-PreamblesPerSSB-PerSharedRO parameter, which is only applicable for shared ROs.

Accordingly, the UE may determine the configuration of PRACH occasions 402 or baseline ROs 502 in 2-step random access through the RACH-ConfigCommonTwoStepRA information element or a similar configuration. The RACH configuration including this information element may indicate the location of a baseline RO in the time and frequency domains and the number of preambles mapped to the baseline RO. If the msgA-CB-PreamblesPerSSB-PerSharedRO-r16 parameter is present, it indicates that the baseline RO is shared, and the UE can use it for both 2-step and 4-step RACH. If the parameter is absent, the UE may determine that the baseline RO is dedicated to the 2-step RACH and thus unshared.

However, it is important to note that none of the parameters in the RACH-ConfigCommonTwoStepRA information element, or other configuration 602 indicating RACH parameters, apply to additional ROs 504 that are dynamically activated or deactivated for NES. Rather, these parameters only provide for baseline ROs 502 to be shared dependent on SSB mapping. Accordingly, aspects of the present disclosure optimize the 2-step random access procedure by providing for a configuration of additional ROs 504 independent of SSB mapping that may indicate their shared RO status. Such configuration would provide for flexibility in configuring these additional ROs to thereby enhance network performance and energy efficiency.

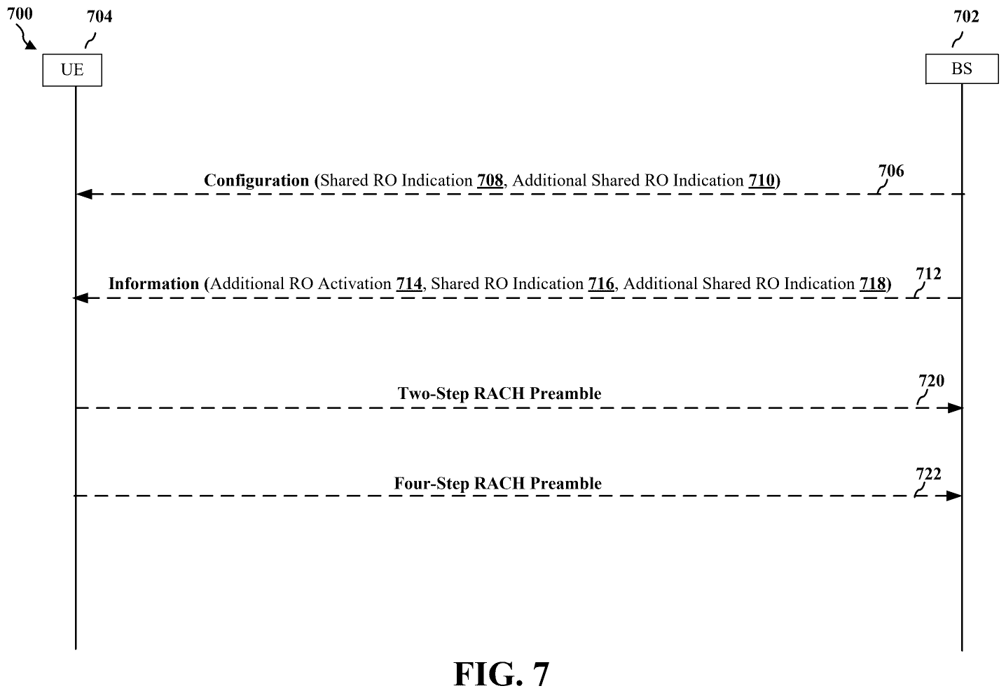

FIG. 7 illustrates an example 700 of a call flow diagram between a base station 702 and a UE 704 illustrating various aspects of the present disclosure. Here, base station 702 may correspond to base station 102, 310, and UE 704 may correspond to UE 104, 350. Initially, the base station 702 may transmit a configuration 706 to the UE 704. The configuration 706 may be, for example, a RACH configuration, such as the configuration 602 or information element of FIG. 6, or a RRC configuration including or associated with such configuration 602 or information element. The configuration 706 may include a shared RO indication 708, such as shared RO parameter 604 in FIG. 6, which indicates to the UE whether baseline ROs 502 are shared between two-step random access and four-step random access or unshared and thus dedicated to two-step random access. The configuration may also include an additional shared RO indication 710, similar to shared RO indication 708, which indicates to the UE whether additional ROs 504 are shared between two-step random access and four-step random access or unshared and thus dedicated to two-step random access.

Subsequently, the base station 702 may transmit information 712 to the UE 704. The information 712 may include an additional RO activation 714. For example, information 712 may be a MAC-CE or DCI that activates additional ROs 504 configured in a RACH configuration. The information 712, or separate information, may include at least one of a shared RO indication 716 or an additional shared RO indication 718. Shared RO indication 716 may be similar to shared RO indication 708, but be an additional parameter included in information 712 on top of the shared RO indication 708 included in configuration 706. Additional shared RO indication 718 may be the same as or correspond to additional shared RO indication 710, but be included in information 712 instead of or in addition to being included in configuration 706.

Following reception of the configuration 706 and information 712, the UE 704 may transmit either a two-step RACH preamble 720 or a four-step RACH preamble 722 in the additional ROs based at least in part on the additional shared RO indication 710 or 718 included in configuration 706 or information 712. For example, if the UE determines from additional shared RO indication 710 or 718 that the additional ROs 504 are not shared between two-step RACH and four-step RACH, the UE may transmit two-step RACH preamble 720 in the additional ROs 504. Alternatively, if the UE determines from additional shared RO indication 710 that the additional ROs 504 are shared between two-step RACH and four-step RACH, the UE may transmit two-step RACH preamble 720 or four-step RACH preamble 722 in the additional ROs 504 depending on the preamble the UE selects from the preambles split between the two-step and four-step RACH processes. Subsequently, the UE may perform the rest of the two-step or four-step RACH process depending on which preamble 720 or 722 is transmitted to the base station 702. For example, the UE may transmit PUSCH in an associated PUSCH occasion in msgA if the selected preamble is associated with two-step RACH, or the UE may wait for a random access response from the base station before transmitting PUSCH in an associated PUSCH occasion if the selected preamble is associated with four-step RACH.

In a first aspect of the present disclosure, additional ROs 504 and baseline ROs 502 may be indicated, for example in configuration 706 or information 712, to share the same preambles for both 2-step and 4-step RACH processes. Alternatively, the additional ROs 504 and baseline ROs 502 may be configured differently in this context. In the former example, the additional ROs 504 may be configured to share preambles with baseline ROs 502 such that a single additional RO may serve both the 2-step and 4-step RACH processes. For example, if a baseline RO has 32 preambles, 16 of these preambles might be allocated in an additional RO for the 2-step RACH and the other 16 of these preambles might be allocated in the additional RO for the 4-step RACH. This sharing allows the network to serve a wider range of UEs, including those with both low and high SSB-RSRP. In the latter example, the additional ROs may be configured differently from baseline ROs, allowing for more precise control over preamble mapping. For instance, the additional ROs 504 may include preambles dedicated exclusively to either the 2-step or the 4-step RACH process independently of the preambles mapped to the baseline ROs 502, depending on the network's needs. For example, if a baseline RO has 32 preambles dedicated only for two-step random access such that the RO is unshared, 16 different preambles might be allocated in an additional RO for the 2-step RACH and another 16 different preambles might be allocated in the additional RO for the 4-step RACH.

In the former example, when the network activates additional ROs 504, the UE 704 may determine whether the baseline ROs 502 will be shared and, if so, the additional ROs 504 will share the same ratio of preambles as the baseline ROs 502. The UE may determine the configuration of the baseline ROs 502, for example from the configuration 602 of FIG. 6, and the UE may determine the timing of the additional ROs 504 based on a scaled periodicity of the baseline ROs 502. In the latter example, regardless of whether the baseline ROs 502 are configured to share preambles between four-step random access and two-step random access, the network may have flexibility to optimize resource utilization of additional ROs 504 based on current traffic loads and conditions. For instance, even if the baseline ROs 502 are not shared, the additional ROs 504 may still be configured to be shared such as illustrated in FIG. 5. The additional ROs 504 may have the flexibility to be shared or not, independent of the baseline ROs' configuration. Thus, in either example, the network may adapt to varying conditions and requirements without being constrained by the configuration of baseline ROs, allowing the network to serve a broader range of UEs.

In some examples, the RRC configuration related to shared additional ROs 504 may be defined by the RACH-ConfigCommonTwoStepRA information element illustrated for example in FIG. 6. This element may specify same or different parameters and conditions under which shared additional ROs are configured and utilized. For instance, a same or similar parameter to msgA-TotalNumberOfRA-Preambles-r16, which defines the total number of RA preambles available for the 2-step RA procedure, and a same or similar parameter to msgA-SSB-PerRACH-OccasionAndCB-PreamblesPerSSB-r16, which specifies the number of preambles per SSB for each RACH occasion, may be applied to additional ROs 504 as well as baseline ROs 502. These additional ROs may either share the preambles configured for baseline ROs in these parameter(s), or the additional ROs may be configured differently with same or different parameter(s).

In one example, the additional ROs 504 may be dynamically activated or deactivated in information 712 based on network conditions and requirements. The additional ROs 504 may be introduced, for example, by scaling the periodicity of the baseline ROs 502. For example, if the configured periodicity for baseline ROs 502 is 80 milliseconds, the periodicity may be scaled to 20 milliseconds to introduce these additional ROs without altering the configuration of baseline ROs 502. This approach allows the additional ROs to be dynamically managed without affecting the baseline ROs' configuration.

In a second aspect of the present disclosure, a dedicated parameter in the RRC configuration of FIG. 6, or more generally in configuration 706, may be provided to enhance the flexibility and efficiency of the two-step random access procedure for NES-capable UEs. In one example, additional shared RO indication 710 may be the dedicated parameter in this aspect, which dedicated parameter may be transmitted additionally to the baseline, shared RO parameter 604 given by shared RO indication 708. The dedicated parameter may serve to differentiate non-NES capable UEs and NES-capable UEs in the context of shared ROs. This dedicated parameter may apply to the additional ROs 504 introduced for NES purposes, providing a more granular and efficient configuration of shared ROs.

More particularly, in the configuration 602 of FIG. 6, the baseline parameter msgA-CB-PreamblesPerSSB-PerSharedRO-r16 may be optionally configured for baseline ROs 502 of non-NES capable UEs. As previously described, this shared RO parameter 604 may define the number of contention-based preambles used for the 2-step random access type from the non-CBRA 4-step type preambles associated with each SSB for ROs shared with the 4-step type random access. Moreover, to optimize the random access procedure for NES-capable UEs, a separate dedicated parameter, such as msgA-CB-PreamblesPerSSB-PerSharedRO-r19 or a different name, may be defined in configuration 602 or a different RRC configuration. This dedicated parameter may specifically apply to the additional ROs 504 introduced for NES purposes. By defining a separate parameter for NES-capable UEs in this manner, the network may more effectively manage the allocation of preambles in shared ROs, tailored to the unique requirements of NES-capable UEs.

The introduction of a dedicated parameter such as msgA-CB-PreamblesPerSSB-PerSharedRO-r19 may allow for a more granular and efficient configuration of shared ROs. This parameter may ensure that the additional ROs 504 can be dynamically managed to optimize resource utilization and energy efficiency. For instance, the network may configure the number of contention-based preambles for NES-capable UEs independently of the baseline configuration for non-NES capable UEs. This separation provides greater flexibility in adapting to varying network conditions and traffic loads.

After the network activates additional ROs 504, the UE may determine whether these ROs will be shared and, if so, whether they will share the same ratio of preambles as the baseline ROs 502. The dedicated parameter such as msgA-CB-PreamblesPerSSB-PerSharedRO-r19 may dictate the configuration of these additional ROs 504. If the baseline, shared RO parameter 604 does not exist or is not provided, the UE may determine that the baseline ROs 502 are not shared. Similarly, if the dedicated parameter such as msgA-CB-PreamblesPerSSB-PerSharedRO-r19 does not exist or is not provided, it indicates that the additional ROs 504 are not shared. Thus, various combinations of shared and unshared ROs may be configured, and the UE may determine from the configuration 602 or 706 which ROs (baseline and additional) are shared and which are not. The baseline ROs 502 may be managed using the baseline, shared RO parameter shown in FIG. 6, while the additional ROs 504 may be managed using the dedicated parameter. This dual-parameter approach provides the network with the flexibility to configure ROs based on specific needs and conditions, ensuring optimal resource utilization and energy efficiency.

In various examples, if the non-NES capable UE parameter (msgA-CB-PreamblesPerSSB-PerSharedRO-r16) is not configured, the baseline ROs are purely for the 2-step RACH. However, if the dedicated parameter is defined, it indicates the sharing properties for the additional ROs. The UE may follow the dedicated parameter for the additional ROs, ensuring that the network can dynamically manage the allocation of preambles.

In one example, if the shared RO indication 708 such as msgA-CB-PreamblesPerSSB-PerSharedRO-r16 is not configured for non-NES capable UEs, it indicates that the baseline ROs 502 are not shared. However, by defining the additional shared RO indication 710 such as msgA-CB-PreamblesPerSSB-PerSharedRO-r19, the UE may determine that the additional ROs 504 are shared. This ensures that the additional ROs 504 can be dynamically managed to optimize resource utilization and energy efficiency. Conversely, in another example, if the shared RO indication 708 such as msgA-CB-PreamblesPerSSB-PerSharedRO-r16 is configured for non-NES capable UEs, it indicates that the baseline ROs 502 are shared for the number of preambles given by this shared RO parameter 604. In this case, if the additional shared RO indication 710 such as msgA-CB-PreamblesPerSSB-PerSharedRO-r19 is also defined, the UE may follow a different or same number of preambles specified by this dedicated parameter for the additional ROs. This separation provides greater flexibility in adapting to varying network conditions and traffic loads. Moreover, in an additional example to further enhance flexibility, the dedicated parameter msgA-CB-PreamblesPerSSB-PerSharedRO-r19 may take a value of zero to explicitly enable non-shared ROs. This allows the network to dynamically configure the additional ROs based on real-time conditions, ensuring optimal resource utilization and minimizing energy consumption.

Thus, the value of the additional shared RO indication 710 may range from zero, to enable non-shared ROs, to any positive integer indicating the number of shared preambles. If the dedicated parameter does not exist or has a zero value, it implies that the additional ROs 504 are not shared. If it exists and specifies a value, it indicates the number of preambles allocated to these additional ROs for the 2-step RACH process. For instance, a value of one means one preamble is allocated for the 2-step RACH, a value of two means two preambles, and so on. This flexibility allows the network to dynamically manage the sharing properties of the additional ROs based on current needs.

In a third aspect of the present disclosure, a flexible approach to managing additional ROs 504 in the 2-step random access procedure may be provided for optimizing network performance and energy efficiency, particularly in the context of NES-capable UEs. In scenarios where the baseline ROs 502 are not shared, the additional ROs 504 may be configured to be shared, for example, in configuration 706 or information 712. Thus, even if the baseline ROs 502 are dedicated exclusively to the 2-step RACH process, the newly introduced additional ROs 504 may be configured to serve both processes.

In one example, the additional ROs 504 may be configured to have the same number of 2-step preambles as the baseline ROs 502. This allows the capacity for the 2-step RACH process to remain consistent, even with the introduction of additional ROs 504. For example, if the baseline ROs 502 have 32 preambles dedicated for 2-step random access, the additional ROs 504 may be configured to also have 32 preambles shared between 2-step and 4-step random access such as 16 for two-step and 16 for four-step. The network may dynamically activate these additional ROs 504 to handle increased traffic or specific network conditions, providing a seamless extension of the baseline ROs 502.

Alternatively, the total number of preambles mapped to the additional ROs 504 may be configured to be the same as the those mapped to the baseline ROs 502. In this case, the preambles may be split between the baseline ROs 502 and the additional ROs 504, allowing for shared usage. For example, if the baseline ROs 502 have 32 preambles dedicated for 2-step random access, the baseline ROs 502 and additional ROs 504 may be configured to together have 32 preambles shared between the 2-step and 4-step RACH processes in the additional ROs 504. Thus, for example, the baseline ROs 502 may be modified to have 16 preambles dedicated for the 2-step RACH process, while the additional ROs 504 may be configured to have the remaining 16 preambles shared between 2-step and 4-step RACH processes such as 8 for two-step and 8 for four-step. This sharing allows the network to serve a broader range of UEs, including those with varying SSB-RSRP levels, without increasing the total number of preambles mapped across baseline ROs 502 and additional ROs 504.

Thus, in this aspect, the network may introduce new preambles for the additional ROs 504 on top of the ones configured for baseline ROs 502, or the network maintain the total number of preambles per RO and split them between the 2-step and 4-step RACH processes. For instance, if a baseline RO has 16 preambles and is not shared, the network may introduce additional ROs that are shared. The total number of preambles may either remain 16, split between the 2-step and 4-step RACH processes, or the network may add new preambles, resulting in 16 preambles in the baseline ROs for the two-step random access and additional preambles in the additional ROs for the four-step random access.

The decision on how to configure the preambles may depend on the network's expectations regarding collision probability. For example, more preambles may help reduce collision probability but may also increase the difficulty in detecting which preamble was transmitted due to the closer proximity of the peaks corresponding to each preamble. Conversely, fewer preambles with greater separation may reduce the misdetection probability but may increase the collision probability. The network may thus determine whether to add new preambles or keep the same total number of preambles across ROs based on one or more of these considerations, and the additional shared RO indication 710 may be configured to indicate one of these approaches accordingly. Thus, the UE 704 may determine whether additional preambles or a split of existing preambles are mapped to additional ROs 504 from the additional shared RO indication 710.

The configuration 602 of FIG. 6 may include one or more parameters indicating the total number of preambles for the additional ROs. If these parameter(s) are missing or not provided, the UE may assume the same configuration for the additional ROs 504 as the baseline ROs 502. However, if a new parameter for NES-capable UEs is present, it may apply to the additional ROs 504, specifying the total number of preambles and allowing the UE to determine the split between the 2-step and 4-step RACH processes.

In a fourth aspect of the present disclosure, a dynamic approach to managing additional ROs 504 in two-step random access may be provided. In this aspect, the network may provide, via additional shared RO indication 718, a dynamic indication to the UE of whether the additional ROs 504 will be shared or not. More particularly, the base station 702 may dynamically indicate the status of the additional ROs 504, specifying whether they will be shared between the 2-step and 4-step RACH processes or remain unshared. This dynamic indication provides the network with the flexibility to adapt to varying traffic loads and conditions in real-time, ensuring efficient resource utilization and minimizing energy consumption.

The dynamic indication may be implemented through signaling that informs the UE about the configuration of the additional ROs 504. For example, instead of relying on semi-static configurations through system information or RRC configurations to indicate the shared RO status of these additional ROs 504, such as configuration 706, the network may utilize a dynamic indication in information 712 such as DCI or MAC-CE signaling or other information signaling of additional shared RO indication 718. This approach allows the network to dynamically activate additional ROs 504 and specify in the same signaling or different signaling whether these ROs are shared or not, providing greater degrees of freedom in network management.

By dynamically indicating the sharing status of the additional ROs 504, the network may make real-time decisions based on current conditions. For example, during periods of high traffic, the network may choose to share the additional ROs 504 between two-step random access and four-step random access to maximize resource availability and serve more UEs. Conversely, during periods of low traffic, the network may decide to keep the additional ROs unshared to reduce complexity and potential interference. This dynamic approach thus ensures that the network can respond to changing conditions without being constrained by static configurations.

The dynamic indication may also incorporate elements from one or more other aspects of the present disclosure. For instance, information 712 may further indicate, on top of additional shared RO indication 718, whether the additional ROs 504 will follow the configurations described with respect to the third aspect of the present disclosure, such as whether the preambles will be split between the 2-step and 4-step RACH processes or if new preambles will be introduced. This integration allows for a comprehensive and flexible approach to managing ROs, ensuring that the network can adapt to a wide range of scenarios.

In a fifth aspect of the present disclosure, dynamic adaptation of the sharing properties of baseline ROs 502 in two-step random access may be provided. In this aspect, the network may leverage the dynamic signaling already in place for additional ROs 504 such as information 712, or different dynamic signaling, to also adapt the sharing properties of baseline ROs 502. More particularly, the network may dynamically change the sharing properties of baseline ROs 502, for example via shared RO indication 716, allowing these ROs to be shared between the 2-step and 4-step RACH processes or unshared as needed.

This dynamic adaptation provides the network with the ability to respond to real-time conditions and requirements, optimizing resource utilization and minimizing energy consumption. The dynamic indication may be implemented through signaling in information 712 such as DCI or MAC-CE or other information signaling, which dynamically indicates whether the baseline ROs 502 will be shared or remain unshared. By leveraging these signaling mechanisms, the network can make real-time adjustments to the sharing properties of baseline ROs without requiring a static configuration.

This approach allows the network to maximize resource availability and efficiency. For instance, during periods of high traffic, the network may dynamically configure baseline ROs 502 to be shared, thereby increasing the capacity to serve more UEs. Conversely, during periods of low traffic, the network may revert the baseline ROs 502 to an unshared configuration to reduce complexity and potential interference. The ability to dynamically adapt the sharing properties of baseline ROs 502 ensures that the network can maintain optimal performance and energy efficiency. This flexibility may be helpful for managing varying traffic loads and conditions, providing an adaptable and efficient framework for resource management.

For instance, in the dynamic signaling the UE receives for adapting the additional ROs such as information 712 including additional shared RO indication 718, the UE may be indicated with a similar capability for baseline ROs 502 as well. This allows the network to dynamically indicate whether the baseline ROs 502 will be shared or not when the additional ROs 504 are activated. The dynamic indication may specify whether the baseline ROs 502 will be shared between the 2-step and 4-step RACH processes or remain dedicated to one RACH process. It may also indicate the number of preambles that will be shared, providing a detailed configuration for the UEs.

Thus, the dynamic indication may be similar to the dynamic signaling of the fourth aspect of the present disclosure, with an additional field in the DCI or MAC-CE specifying the sharing properties of the baseline ROs 502. This field may indicate whether the baseline ROs 502 are shared or not, and how many preambles are allocated for sharing. The dynamic indication mechanism may thus provide a comprehensive framework for managing both baseline and additional ROs, ensuring optimal resource utilization and network performance.

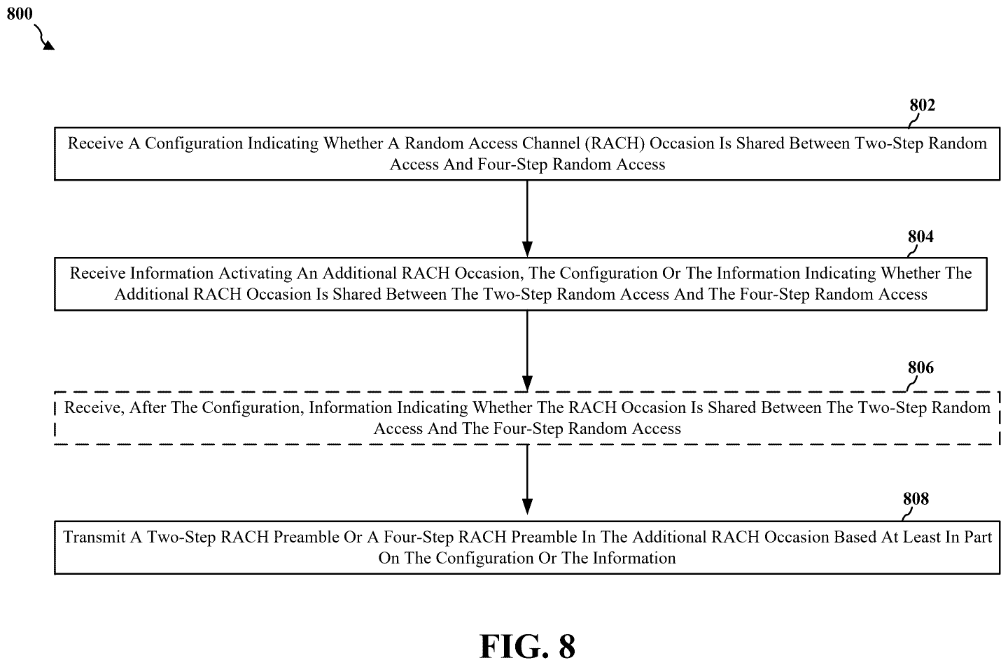

FIG. 8 is a flowchart 800 of an example method or process for wireless communication. The method may be performed by a UE such as the UE 104, 350, or apparatus 902 or its components as described herein. Optional aspects are illustrated in dashed lines. The method allows for the dynamic adaptation and sharing of RACH occasions in 5G NR networks to optimize resource utilization, reduce latency, and improve energy efficiency.

At block 802, the UE may receive a configuration indicating whether a RACH occasion is shared between two-step random access and four-step random access. For example, block 802 may be performed by configuration component 940. For instance, referring to the Figures, the controller(s)/processor(s) 359, the RX processor(s) 356, or a combination of these processor(s) of UE 704 may decode, demodulate, and receive via antennas 352, configuration 602, 706 indicating via shared RO parameter 604 whether baseline ROs 502 are shared between two-step random access and four-step random-access.

At block 804, the UE may receive information activating an additional RACH occasion, the configuration or the information indicating whether the additional RACH occasion is shared between the two-step random access and the four-step random access. For example, block 804 may be performed by information component 942. For instance, referring to the Figures, the controller(s)/processor(s) 359, the RX processor(s) 356, or a combination of these processor(s) of UE 704 may decode, demodulate, and receive via antennas 352, information 712 activating additional ROs 504, for example via additional RO activation 714. The configuration 706 or information 712 may indicate, for example via additional shared RO indication 710 or 718, whether additional ROs 504 are shared between two-step random access and four-step random access.

In one example, the configuration indicates that the RACH occasion and the additional RACH occasion are both shared between the two-step random access and the four-step random access, or the configuration indicates that the RACH occasion and the additional RACH occasion are both not shared between the two-step random access and the four-step random access. For instance, referring to the Figures, configuration 706 may indicate, for example via shared RO indication 708, additional shared RO indication 710, or a combination of shared RO indication 708 and additional shared RO indication 710, that baseline ROs 502 and additional ROs 504 are both shared or not shared between two-step random access or four-step random access. As an example, with reference to one example of the first aspect of the present disclosure, additional ROs 504 and baseline ROs 502 may be indicated via one or more of these indication(s) 708, 710 to share the same preambles for both 2-step and 4-step RACH processes.

In one example, the configuration indicates that the RACH occasion is shared between the two-step random access and the four-step random access and that the additional RACH occasion is not shared between the two-step random access and the four-step random access, or the configuration indicates that the RACH occasion is not shared between the two-step random access and the four-step random access and that the additional RACH occasion is shared between the two-step random access and the four-step random access. For instance, referring to the Figures, configuration 706 may indicate, for example via shared RO indication 708, that baseline ROs 502 are either shared or not shared between two-step random access or four-step random access, while separately indicating, for example via additional shared RO indication 710, that additional ROs 504 are either shared or not shared between two-step random access or four-step random access. As an example, with reference to another example of the first aspect of the present disclosure, the additional ROs 504 may be configured differently from baseline ROs 502, allowing for more precise control over preamble mapping. For instance, baseline ROs 502 and additional ROs 504 may be separately indicated via indication(s) 708, 710 to share different preambles from each other for both 2-step and 4-step RACH processes.

In one example, the configuration includes a first RACH parameter indicating whether the RACH occasion is shared between the two-step random access and the four-step random access, and the configuration includes a second RACH parameter, separate from the first RACH parameter, indicating whether the additional RACH occasion is shared between the two-step random access and the four-step random access. For instance, referring to the Figures, configuration 706 may include shared RO parameter 604 indicating whether baseline ROs 502 are shared between two-step random access and four-step random access, and configuration 706 may include a different, separate parameter than shared RO parameter 604 indicating whether additional ROs 504 are shared between two-step random access and four step random access. The shared RO indication 708 may be the shared RO parameter 604 in one example, while the additional shared RO indication 710 may be the different, separate parameter dedicated for additional ROs 504. As an example, with respect to one example of the second aspect of the present disclosure, in the configuration 602 of FIG. 6, the baseline parameter msgA-CB-PreamblesPerSSB-PerSharedRO-r16 may be optionally configured for baseline ROs 502 of non-NES capable UEs, while a separate dedicated parameter, such as msgA-CB-PreamblesPerSSB-PerSharedRO-r19 or a different name, may be defined in configuration 602 or a different RRC configuration to specifically apply to the additional ROs 504 introduced for NES purposes.

In one example, the configuration lacks a first RACH parameter indicating whether the RACH occasion is shared between the two-step random access and the four-step random access, the lack of the first RACH parameter indicating that the RACH occasion is not shared, and the configuration includes a second RACH parameter, separate from the first RACH parameter, indicating that the additional RACH occasion is shared between the two-step random access and the four-step random access. For instance, referring to the Figures, configuration 706 may lack shared RO parameter 604 indicating whether baseline ROs 502 are shared between two-step random access and four-step random access, and configuration 706 may include a different, separate parameter than shared RO parameter 604 indicating whether additional ROs 504 are shared between two-step random access and four step random access. The shared RO indication 708 may be the shared RO parameter 604 in one example, while the additional shared RO indication 710 may be the different, separate parameter dedicated for additional ROs 504. The omission of shared RO indication 708 may indicate to UE 704 that the baseline ROs 502 are not shared between the different random access types. As an example, with respect to another example of the second aspect of the present disclosure, in the configuration 602 of FIG. 6, if the shared RO indication 708 such as msgA-CB-PreamblesPerSSB-PerSharedRO-r16 is not configured for non-NES capable UEs, it indicates that the baseline ROs 502 are not shared. However, if the additional shared RO indication 710 such as msgA-CB-PreamblesPerSSB-PerSharedRO-r19 or a different name is defined, the UE may determine that the additional ROs 504 are shared.

In one example, the configuration includes a first RACH parameter indicating that the RACH occasion is shared between the two-step random access and the four-step random access for a first quantity of RACH preambles, and the configuration includes a second RACH parameter, separate from the first RACH parameter, indicating that the additional RACH occasion is shared between the two-step random access and the four-step random access for a second, different quantity of RACH preambles. For instance, referring to the Figures, configuration 706 may include shared RO parameter 604 indicating whether baseline ROs 502 are shared between two-step random access and four-step random access for one number of preambles indicated in this parameter, and configuration 706 may include a different, separate parameter than shared RO parameter 604 indicating whether additional ROs 504 are shared between two-step random access and four step random access for a different number of preambles indicated in this parameter. The shared RO indication 708 may be the shared RO parameter 604 in one example, while the additional shared RO indication 710 may be the different, separate parameter dedicated for additional ROs 504. As an example, with respect to another example of the second aspect of the present disclosure, in the configuration 602 of FIG. 6, if the shared RO indication 708 such as msgA-CB-PreamblesPerSSB-PerSharedRO-r16 is configured for non-NES capable UEs, it indicates that the baseline ROs 502 are shared for the number of preambles given by this shared RO parameter 604. In this case, if the additional shared RO indication 710 such as msgA-CB-PreamblesPerSSB-PerSharedRO-r19 is also defined, the UE may follow a different number of preambles specified by this dedicated parameter for the additional ROs 504.

In one example, the configuration includes a first RACH parameter indicating whether the RACH occasion is shared between the two-step random access and the four-step random access, and the configuration includes a second RACH parameter, separate from the first RACH parameter, that includes a zero value indicating that the additional RACH occasion is not shared between the two-step random access and the four-step random access. For instance, referring to the Figures, configuration 706 may include shared RO parameter 604 indicating whether baseline ROs 502 are shared between two-step random access and four-step random access, and configuration 706 may include a different, separate parameter than shared RO parameter 604 including a zero value indicating that additional ROs 504 are not shared between two-step random access and four step random access. The shared RO indication 708 may be the shared RO parameter 604 in one example, while the additional shared RO indication 710 may be the different, separate parameter dedicated for additional ROs 504. As an example, with respect to a further example of the second aspect of the present disclosure, in the configuration 602 of FIG. 6, if the shared RO indication 708 such as msgA-CB-PreamblesPerSSB-PerSharedRO-r16 is configured for non-NES capable UEs, it indicates that the baseline ROs 502 are shared for the number of preambles given by this shared RO parameter 604. In this case, if the additional shared RO indication 710 such as msgA-CB-PreamblesPerSSB-PerSharedRO-r19 is configured with a value of zero, that indicates the additional ROs 504 are not shared.

In one example, the configuration indicates that the RACH occasion is not shared between the two-step random access and the four-step random access and that the additional RACH occasion is shared between the two-step random access and the four-step random access, and the additional RACH occasion and the RACH occasion are both associated with a same number of two-step RACH preambles. For instance, referring to the Figures, configuration 706 may indicate via shared RO indication 708 that baseline ROs 502 are not shared between two-step random access and four-step random access, but indicate via additional shared RO indication 710 that additional ROs 504 are shared between two-step random access and four-step random access. In such case, additional shared RO indication 710 or other parameter in configuration 706 may indicate that baseline ROs 502 and additional ROs 504 are associated with a same number of RACH preambles for two-step random access. As an example, with respect to one example of the third aspect of the present disclosure, if the baseline ROs 502 have 32 preambles dedicated for 2-step random access, the additional ROs 504 may be configured to also have 32 preambles shared between 2-step and 4-step random access such as 16 for two-step and 16 for four-step.

In one example, the configuration indicates that the RACH occasion is not shared between the two-step random access and the four-step random access and that the additional RACH occasion is shared between the two-step random access and the four-step random access, and the additional RACH occasion and the RACH occasion are together associated with a total number of two-step RACH preambles split between the additional RACH occasion and the RACH occasion. For instance, referring to the Figures, configuration 706 may indicate via shared RO indication 708 that baseline ROs 502 are not shared between two-step random access and four-step random access, but indicate via additional shared RO indication 710 that additional ROs 504 are shared between two-step random access and four-step random access. In such case, additional shared RO indication 710 or other parameter in configuration 706 may indicate that baseline ROs 502 and additional ROs 504 are associated with a total number of RACH preambles for two-step random access split between the baseline ROs and additional ROs. As an example, with respect to another example of the third aspect of the present disclosure, if the baseline ROs 502 have 32 preambles dedicated for 2-step random access, the baseline ROs 502 and additional ROs 504 may be configured to together have 32 preambles shared between the 2-step and 4-step RACH processes in the additional ROs 504. Thus, for example, the baseline ROs 502 may be modified to have 16 preambles dedicated for the 2-step RACH process, while the additional ROs 504 may be configured to have the remaining 16 preambles shared between 2-step and 4-step RACH processes such as 8 for two-step and 8 for four-step.

In one example, the information indicates whether the additional RACH occasion is shared between the two-step random access and the four-step random access. For instance, referring to the Figures, information 712 may indicate via additional shared RO indication 718 whether additional ROs 504 are shared between two-step random access and four-step random access. As an example, with respect to the fourth aspect of the present disclosure, the base station 702 may dynamically indicate the status of the additional ROs 504, specifying whether they will be shared between the 2-step and 4-step RACH processes or remain unshared, in DCI or MAC-CE signaling.

At block 806, the UE may receive, after the configuration, information indicating whether the RACH occasion is shared between the two-step random access and the four-step random access. For example, block 806 may be performed by information component 942. For instance, referring to the Figures, the controller(s)/processor(s) 359, the RX processor(s) 356, or a combination of these processor(s) of UE 704 may decode, demodulate, and receive via antennas 352, after receiving configuration 706, information 712 or different information indicating, for example via shared RO indication 716, whether baseline ROs 502 are shared between two-step random access and four-step random access. As an example, with respect to the fifth aspect of the present disclosure, the base station 702 may dynamically change the sharing properties of baseline ROs 502, for example via shared RO indication 716 in DCI or MAC-CE or other information signaling, allowing these ROs to be shared between the 2-step and 4-step RACH processes or unshared as needed.

Finally, at block 808, the UE may transmit a two-step RACH preamble or a four-step RACH preamble in the additional RACH occasion based at least in part on the configuration or the information. For example, block 808 may be performed by preamble component 944. For instance, referring to the Figures, the controller(s)/processor(s) 359, the TX processor(s) 368, or a combination of these processor(s) of UE 704 may encode, modulate, and transmit via antennas 352, two-step RACH preamble 720 or four-step RACH preamble 722 in one or more of additional ROs 504 based at least in part on configuration 706 or information 712. For example, if the configuration 706 or information 712 indicates that the additional RACH occasion is shared between two-step and four-step random access, the UE may select and transmit the appropriate preamble type based on its SSB-RSRP or other signal quality metric. For instance, if the UE has a higher SSB-RSRP, it may transmit the two-step RACH preamble in that RO, while if it has a lower SSB-RSRP, it may transmit the four-step RACH preamble in that RO. If the configuration 706 or information 712 indicates that the additional RACH occasion is not shared, the UE may transmit the two-step RACH preamble in that RO.

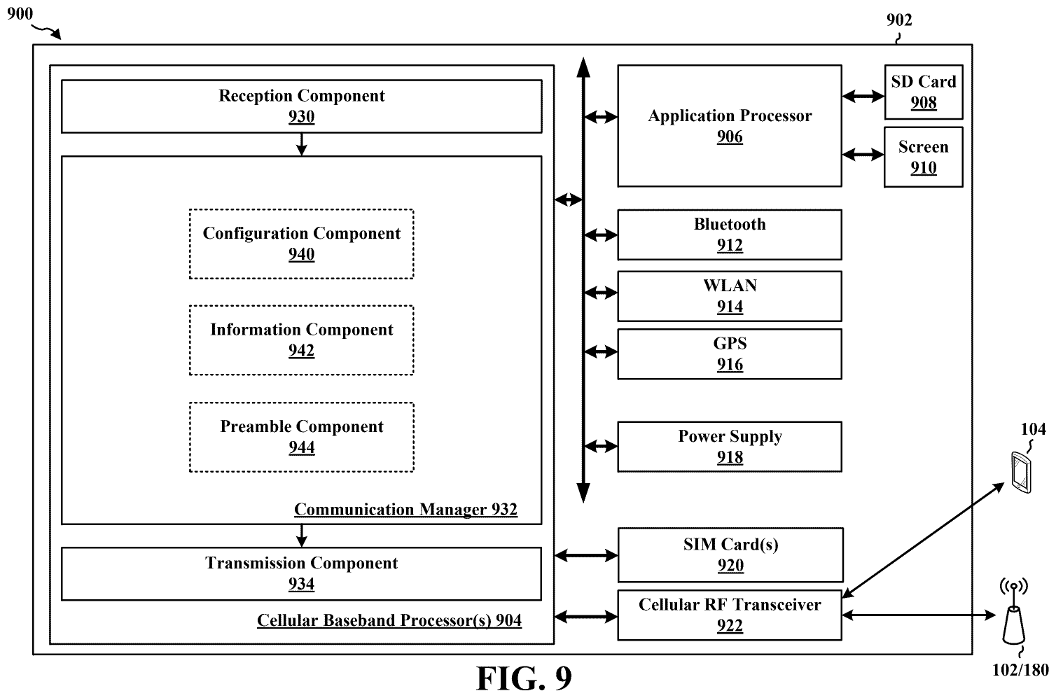

FIG. 9 is a diagram 900 illustrating an example of a hardware implementation for an apparatus 902 according to the various aspects of the present disclosure. In one example, the apparatus 902 may be a UE such as UE 104, 350, 704 and includes one or more cellular baseband processors 904 (also referred to as a modem) coupled to a cellular RF transceiver 922 and one or more subscriber identity modules (SIM) cards 920, an application processor 906 coupled to a secure digital (SD) card 908 and a screen 910, a Bluetooth module 912, a wireless local area network (WLAN) module 914, a Global Positioning System (GPS) module 916, and a power supply 918. The one or more cellular baseband processors 904 communicate through the cellular RF transceiver 922 with the BS 102 or another UE 104. For example, the cellular RF transceiver 922 may correspond to or include the transmitters 354TX, receivers 354RX, and antennas 352 of UE 350.

The one or more cellular baseband processors 904 may each include a computer-readable medium/one or more memories. The computer-readable medium/one or more memories may be non-transitory. The one or more cellular baseband processors 904 are responsible for general processing, including the execution of software stored on the computer-readable medium/one or more memories individually or in combination. The software, when executed by the one or more cellular baseband processors 904, causes the one or more cellular baseband processors 904 to, individually or in combination, perform the various functions described supra. The computer-readable medium/one or more memories may also be used individually or in combination for storing data that is manipulated by the one or more cellular baseband processors 904 when executing software. The one or more cellular baseband processors 904 individually or in combination further include a reception component 930, a communication manager 932, and a transmission component 934. The communication manager 932 includes the one or more illustrated components. The components within the communication manager 932 may be stored in the computer-readable medium/one or more memories and/or configured as hardware within the one or more cellular baseband processors 904. The one or more cellular baseband processors 904 may be components of the UE 104, 350, 704, and may individually or in combination include the one or more memories 360 and/or at least one of the one or more TX processors 368, at least one of the one or more RX processors 356 and at least one of the one or more controllers/processors 359. For example, the computer-readable medium/one or more memories may correspond to or include the one or more memories 360, the reception component 930 may correspond to or include the one or more RX processors 356, the communication manager 932 may correspond to or include the one or more controllers/processors 359, and the transmission component 934 may correspond to or include the one or more TX processors 368. In one configuration, the apparatus 902 may be a modem chip and include just the one or more baseband processors 904, and in another configuration, the apparatus 902 may be the entire UE (e.g., UE 350 of FIG. 3) and include the aforediscussed additional modules of the apparatus 902.

The communication manager 932 may include a configuration component 940 that is configured to receive a configuration indicating whether a RACH occasion is shared between two-step random access and four-step random access, such as described in connection with block 802 of FIG. 8. The communication manager 932 may further include an information component 942 that is configured to receive information activating an additional RACH occasion, the configuration or the information indicating whether the additional RACH occasion is shared between the two-step random access and the four-step random access, such as described in connection with block 804 of FIG. 8. In one configuration, the information component 942 may be configured to receive, after the configuration, information indicating whether the RACH occasion is shared between the two-step random access and the four-step random access, such as described in connection with block 806 of FIG. 8. The communication manager 932 may further include a preamble component 944 that is configured to transmit a two-step RACH preamble or a four-step RACH preamble in the additional RACH occasion based at least in part on the configuration or the information, such as described in connection with block 808 of FIG. 8.

The apparatus may include additional components that perform each of the blocks of the algorithm in the aforementioned flowchart of FIG. 8. As such, each block in the aforementioned flowchart of FIG. 8 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 902, and in particular the one or more cellular baseband processors 904, includes means for receiving a configuration indicating whether a RACH occasion is shared between two-step random access and four-step random access, the means for receiving being further configured to receive information activating an additional RACH occasion, the configuration or the information indicating whether the additional RACH occasion is shared between the two-step random access and the four-step random access, and means for transmitting a two-step RACH preamble or a four-step RACH preamble in the additional RACH occasion based at least in part on the configuration or the information.

In one configuration, the means for receiving may be further configured to receive, after the configuration, information indicating whether the RACH occasion is shared between the two-step random access and the four-step random access.

The aforementioned means may be one or more of the aforementioned components of the apparatus 902 configured to perform the functions recited by the aforementioned means. Moreover, as described supra, the apparatus 902 may include the one or more TX processors 368, the one or more RX processors 356, and the one or more controllers/processors 359. As such, in one configuration, the aforementioned means may be at least one of the one or more TX processors 368, at least one of the one or more RX processors 356, or at least one of the one or more controllers/processors 359, individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.
Clause 1. An apparatus for wireless communication, comprising: one or more memories; and one or more processors each communicatively coupled with at least one of the one or more memories, the one or more processors, individually or in any combination, operable to cause the apparatus to: receive a configuration indicating whether a random access channel (RACH) occasion is shared between two-step random access and four-step random access; receive information activating an additional RACH occasion, the configuration or the information indicating whether the additional RACH occasion is shared between the two-step random access and the four-step random access; and transmit a two-step RACH preamble or a four-step RACH preamble in the additional RACH occasion based at least in part on the configuration or the information.
Clause 2. The apparatus of clause 1, wherein the configuration indicates that the RACH occasion and the additional RACH occasion are both shared between the two-step random access and the four-step random access, or the configuration indicates that the RACH occasion and the additional RACH occasion are both not shared between the two-step random access and the four-step random access.
Clause 3. The apparatus of clause 1, wherein the configuration indicates that the RACH occasion is shared between the two-step random access and the four-step random access and that the additional RACH occasion is not shared between the two-step random access and the four-step random access, or the configuration indicates that the RACH occasion is not shared between the two-step random access and the four-step random access and that the additional RACH occasion is shared between the two-step random access and the four-step random access.
Clause 4. The apparatus of any of clauses 1 to 3, wherein the configuration includes a first RACH parameter indicating whether the RACH occasion is shared between the two-step random access and the four-step random access, and the configuration includes a second RACH parameter, separate from the first RACH parameter, indicating whether the additional RACH occasion is shared between the two-step random access and the four-step random access.
Clause 5. The apparatus of any of clauses 1 to 3, wherein the configuration lacks a first RACH parameter indicating whether the RACH occasion is shared between the two-step random access and the four-step random access, the lack of the first RACH parameter indicating that the RACH occasion is not shared, and the configuration includes a second RACH parameter, separate from the first RACH parameter, indicating that the additional RACH occasion is shared between the two-step random access and the four-step random access.
Clause 6. The apparatus of any of clauses 1 to 3, wherein the configuration includes a first RACH parameter indicating that the RACH occasion is shared between the two-step random access and the four-step random access for a first quantity of RACH preambles, and the configuration includes a second RACH parameter, separate from the first RACH parameter, indicating that the additional RACH occasion is shared between the two-step random access and the four-step random access for a second, different quantity of RACH preambles.
Clause 7. The apparatus of any of clauses 1 to 3, wherein the configuration includes a first RACH parameter indicating whether the RACH occasion is shared between the two-step random access and the four-step random access, and the configuration includes a second RACH parameter, separate from the first RACH parameter, that includes a zero value indicating that the additional RACH occasion is not shared between the two-step random access and the four-step random access.
Clause 8. The apparatus of any of clauses 1 to 7, wherein the configuration indicates that the RACH occasion is not shared between the two-step random access and the four-step random access and that the additional RACH occasion is shared between the two-step random access and the four-step random access, and the additional RACH occasion and the RACH occasion are both associated with a same number of two-step RACH preambles.
Clause 9. The apparatus of any of clauses 1 to 7, wherein the configuration indicates that the RACH occasion is not shared between the two-step random access and the four-step random access and that the additional RACH occasion is shared between the two-step random access and the four-step random access, and the additional RACH occasion and the RACH occasion are together associated with a total number of two-step RACH preambles split between the additional RACH occasion and the RACH occasion.
Clause 10. The apparatus of any of clauses 1 to 9, wherein the information indicates whether the additional RACH occasion is shared between the two-step random access and the four-step random access.
Clause 11. The apparatus of any of clauses 1 to 10, wherein the one or more processors, individually or in any combination, are further operable to cause the apparatus to: receive, after the configuration, information indicating whether the RACH occasion is shared between the two-step random access and the four-step random access.
Clause 12. A method of wireless communication performable at a user equipment (UE), comprising: receiving a configuration indicating whether a random access channel (RACH) occasion is shared between two-step random access and four-step random access; receiving information activating an additional RACH occasion, the configuration or the information indicating whether the additional RACH occasion is shared between the two-step random access and the four-step random access; and transmitting a two-step RACH preamble or a four-step RACH preamble in the additional RACH occasion based at least in part on the configuration or the information.
Clause 13. The method of clause 12, wherein the configuration indicates that the RACH occasion and the additional RACH occasion are both shared between the two-step random access and the four-step random access, the configuration indicates that the RACH occasion and the additional RACH occasion are both not shared between the two-step random access and the four-step random access, the configuration indicates that the RACH occasion is shared between the two-step random access and the four-step random access and that the additional RACH occasion is not shared between the two-step random access and the four-step random access, or the configuration indicates that the RACH occasion is not shared between the two-step random access and the four-step random access and that the additional RACH occasion is shared between the two-step random access and the four-step random access.
Clause 14. The method of clause 12 or clause 13, wherein the configuration includes a first RACH parameter indicating whether the RACH occasion is shared between the two-step random access and the four-step random access, and the configuration includes a second RACH parameter, separate from the first RACH parameter, indicating whether the additional RACH occasion is shared between the two-step random access and the four-step random access.
Clause 15. The method of clause 12 or clause 13, where the configuration includes a first RACH parameter indicating that the RACH occasion is shared between the two-step random access and the four-step random access for a first quantity of RACH preambles, and the configuration includes a second RACH parameter, separate from the first RACH parameter, indicating that the additional RACH occasion is shared between the two-step random access and the four-step random access for a second, different quantity of RACH preambles.
Clause 16. The method of clause 12 or clause 13, wherein the configuration includes a first RACH parameter indicating whether the RACH occasion is shared between the two-step random access and the four-step random access, and the configuration includes a second RACH parameter, separate from the first RACH parameter, that includes a zero value indicating that the additional RACH occasion is not shared between the two-step random access and the four-step random access.
Clause 17. The method of any of clauses 12 to 16, wherein the configuration indicates that the RACH occasion is not shared between the two-step random access and the four-step random access and that the additional RACH occasion is shared between the two-step random access and the four-step random access, and either: the additional RACH occasion and the RACH occasion are both associated with a same number of two-step RACH preambles, or the additional RACH occasion and the RACH occasion are together associated with a total number of two-step RACH preambles split between the additional RACH occasion and the RACH occasion.
Clause 18. The method of any of clauses 12 to 17, wherein the information indicates whether the additional RACH occasion is shared between the two-step random access and the four-step random access.
Clause 19. The method of any of clauses 12 to 18, further comprising: receiving, after the configuration, information indicating whether the RACH occasion is shared between the two-step random access and the four-step random access.
Clause 20. An apparatus for wireless communication, comprising: means for receiving a configuration indicating whether a random access channel (RACH) occasion is shared between two-step random access and four-step random access; the means for receiving being further configured to receive information activating an additional RACH occasion, the configuration or the information indicating whether the additional RACH occasion is shared between the two-step random access and the four-step random access; and means for transmitting a two-step RACH preamble or a four-step RACH preamble in the additional RACH occasion based at least in part on the configuration or the information.

What is claimed is:

1. An apparatus for wireless communication, comprising:
one or more memories; and
one or more processors each communicatively coupled with at least one of the one or more memories, the one or more processors, individually or in any combination, operable to cause the apparatus to:
receive a configuration indicating whether a random access channel (RACH) occasion is shared between two-step random access and four-step random access;
receive information activating an additional RACH occasion, the configuration or the information indicating whether the additional RACH occasion is shared between the two-step random access and the four-step random access; and
transmit a two-step RACH preamble or a four-step RACH preamble in the additional RACH occasion based at least in part on the configuration or the information.

2. The apparatus of claim 1, wherein
the configuration indicates that the RACH occasion and the additional RACH occasion are both shared between the two-step random access and the four-step random access, or
the configuration indicates that the RACH occasion and the additional RACH occasion are both not shared between the two-step random access and the four-step random access.

3. The apparatus of claim 1, wherein
the configuration indicates that the RACH occasion is shared between the two-step random access and the four-step random access and that the additional RACH occasion is not shared between the two-step random access and the four-step random access, or
the configuration indicates that the RACH occasion is not shared between the two-step random access and the four-step random access and that the additional RACH occasion is shared between the two-step random access and the four-step random access.

4. The apparatus of claim 1, wherein
the configuration includes a first RACH parameter indicating whether the RACH occasion is shared between the two-step random access and the four-step random access, and
the configuration includes a second RACH parameter, separate from the first RACH parameter, indicating whether the additional RACH occasion is shared between the two-step random access and the four-step random access.

5. The apparatus of claim 1, wherein
the configuration lacks a first RACH parameter indicating whether the RACH occasion is shared between the two-step random access and the four-step random access, the lack of the first RACH parameter indicating that the RACH occasion is not shared, and
the configuration includes a second RACH parameter, separate from the first RACH parameter, indicating that the additional RACH occasion is shared between the two-step random access and the four-step random access.

6. The apparatus of claim 1, wherein
the configuration includes a first RACH parameter indicating that the RACH occasion is shared between the two-step random access and the four-step random access for a first quantity of RACH preambles, and
the configuration includes a second RACH parameter, separate from the first RACH parameter, indicating that the additional RACH occasion is shared between the two-step random access and the four-step random access for a second, different quantity of RACH preambles.

7. The apparatus of claim 1, wherein
the configuration includes a first RACH parameter indicating whether the RACH occasion is shared between the two-step random access and the four-step random access, and
the configuration includes a second RACH parameter, separate from the first RACH parameter, that includes a zero value indicating that the additional RACH occasion is not shared between the two-step random access and the four-step random access.

8. The apparatus of claim 1, wherein
the configuration indicates that the RACH occasion is not shared between the two-step random access and the four-step random access and that the additional RACH occasion is shared between the two-step random access and the four-step random access, and
the additional RACH occasion and the RACH occasion are both associated with a same number of two-step RACH preambles.

9. The apparatus of claim 1, wherein
the configuration indicates that the RACH occasion is not shared between the two-step random access and the four-step random access and that the additional RACH occasion is shared between the two-step random access and the four-step random access, and
the additional RACH occasion and the RACH occasion are together associated with a total number of two-step RACH preambles split between the additional RACH occasion and the RACH occasion.

10. The apparatus of claim 1, wherein the information indicates whether the additional RACH occasion is shared between the two-step random access and the four-step random access.

11. The apparatus of claim 1, wherein the one or more processors, individually or in any combination, are further operable to cause the apparatus to:
receive, after the configuration, information indicating whether the RACH occasion is shared between the two-step random access and the four-step random access.

12. A method of wireless communication performable at a user equipment (UE), comprising:
receiving a configuration indicating whether a random access channel (RACH) occasion is shared between two-step random access and four-step random access;
receiving information activating an additional RACH occasion, the configuration or the information indicating whether the additional RACH occasion is shared between the two-step random access and the four-step random access; and
transmitting a two-step RACH preamble or a four-step RACH preamble in the additional RACH occasion based at least in part on the configuration or the information.

13. The method of claim 12, wherein
the configuration indicates that the RACH occasion and the additional RACH occasion are both shared between the two-step random access and the four-step random access,
the configuration indicates that the RACH occasion and the additional RACH occasion are both not shared between the two-step random access and the four-step random access,
the configuration indicates that the RACH occasion is shared between the two-step random access and the four-step random access and that the additional RACH occasion is not shared between the two-step random access and the four-step random access, or
the configuration indicates that the RACH occasion is not shared between the two-step random access and the four-step random access and that the additional RACH occasion is shared between the two-step random access and the four-step random access.

14. The method of claim 12, wherein
the configuration includes a first RACH parameter indicating whether the RACH occasion is shared between the two-step random access and the four-step random access, and
the configuration includes a second RACH parameter, separate from the first RACH parameter, indicating whether the additional RACH occasion is shared between the two-step random access and the four-step random access.

15. The method of claim 12, where
the configuration includes a first RACH parameter indicating that the RACH occasion is shared between the two-step random access and the four-step random access for a first quantity of RACH preambles, and
the configuration includes a second RACH parameter, separate from the first RACH parameter, indicating that the additional RACH occasion is shared between the two-step random access and the four-step random access for a second, different quantity of RACH preambles.

16. The method of claim 12, wherein
the configuration includes a first RACH parameter indicating whether the RACH occasion is shared between the two-step random access and the four-step random access, and
the configuration includes a second RACH parameter, separate from the first RACH parameter, that includes a zero value indicating that the additional RACH occasion is not shared between the two-step random access and the four-step random access.

17. The method of claim 12, wherein
the configuration indicates that the RACH occasion is not shared between the two-step random access and the four-step random access and that the additional RACH occasion is shared between the two-step random access and the four-step random access, and
either:
the additional RACH occasion and the RACH occasion are both associated with a same number of two-step RACH preambles, or
the additional RACH occasion and the RACH occasion are together associated with a total number of two-step RACH preambles split between the additional RACH occasion and the RACH occasion.

18. The method of claim 12, wherein the information indicates whether the additional RACH occasion is shared between the two-step random access and the four-step random access.

19. The method of claim 12, further comprising:
receiving, after the configuration, information indicating whether the RACH occasion is shared between the two-step random access and the four-step random access.

20. An apparatus for wireless communication, comprising:
means for receiving a configuration indicating whether a random access channel (RACH) occasion is shared between two-step random access and four-step random access;
the means for receiving being further configured to receive information activating an additional RACH occasion, the configuration or the information indicating whether the additional RACH occasion is shared between the two-step random access and the four-step random access; and
means for transmitting a two-step RACH preamble or a four-step RACH preamble in the additional RACH occasion based at least in part on the configuration or the information.
